(19) United States
(12) Patent Application Publication
(10) Pub. No.: US 2002/0116407 A1
(43) Pub. Date: Aug. 22, 2002

(54) Conversion apparatus and method, accounting method, and script conversion system and method

(76) Inventors: Shinji Negishi, Kanagawa (JP); Hideki Koyanagi, Kanagawa (JP); Yoichi Yagasaki, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/052,171

(22) Filed: Jan. 17, 2002

(30) Foreign Application Priority Data
Jan. 17, 2001 (JP) P2001-009302

(51) Int. Cl. G06F 12/00

(52) U.S. Cl. 707/203

(57) ABSTRACT

A document is sent from a document server to a relay server in response to a document request from a client. A script is then extracted from the document and is separately stored in a script cache. Then, a script calling portion in the document is substituted with a portion for calling the script stored in the script cache. Then, the resulting document is sent to the client. With this arrangement, when the script in the document is called by the client, it is executed by a script execution device of the relay server.

### BACKGROUND OF THE INVENTION

1. Field of the Invention

The present invention relates to a system for executing a script contained in a world wide web (hereinafter referred to as “WWW”) document or in a digital data broadcast, or a script in an operation menu displayed on a remote controller which controls devices connected to a network.

2. Description of the Related Art

Generally, a WWW document is described in a markup language, such as the HyperText Markup Language (HTML), defined by the WWW consortium (hereinafter referred to as “W3C”). WWW resources, such as WWW documents, are uniquely determined by an identifier, which is referred to as a “Universal Resource Identifier (URI)”. URIs are described in RFC 1630. RFC stands for Request for Comments, and is a document issued by the Internet Engineering Task Force (IETF).

The URI includes the Universal Resource Locator (URL), which is formed of a string, such as “http:host:port/path?search”. In this string, “host” indicates the server which provides the resources, such as WWW documents, “port” represents the port number used for connection, “path” designates the resources in the server, and “search” indicates the parameter for the resources. The text “http” indicates that the HyperText Transfer Protocol (HTTP) is used as a data transfer protocol. The HTTP is described in RFC 2068.

The above-described WWW is used by, for example, clients, such as personal computers and portable terminals provided with a document viewing browser. Such clients communicate with a document server by using the HTTP through a user operation, and requests a document by specifying it with the corresponding URL. The document server then extracts the requested document from the stored documents and sends it to the client as an HTTP response message. Alternatively, in response to a document request from the client, the document server may dynamically create the corresponding document and send it to the client.

Some document servers are provided with a common gateway interface (CGI), which serves as a standard interface for executing an external program. In response to a request to execute an external program sent from the client to the document server, the external program is started via the CGI in the document server, and a created document is returned to the client. An example in which the CGI is used by the client through an HTML document is as follows. The client searches a database of the document server to obtain a search result. In this example, the user searches the database and creates a search result document by running an external program.

In the above-described example, the client executes the external program in the document server by using the function of the CGI. Another approach to using the CGI is to embed a program in a document itself or attach the program to the document and to return the resulting document to the client. Such a program is hereinafter referred to as a “script”. An example of the “script” is JavaScript in which scripts can be directly described in a document by using HTML SCRIPT tags. For example, in an HTML document shown in FIG. 3, when a user clicks a character string indicated by “Click here” with a pointing device, the script described within exec( ) of a script portion 202 is executed. For simple representation, the script itself described within exec( ) is not shown in FIG. 3.

Most WWW documents are designed for clients provided with large display screens, for example, for personal computers. For clients provided with small display screens, for example for portable terminals, such as cellular telephones and personal digital assistants (PDA), the transmission capacity for communication is too small and the browser processing performance of such clients is too low.

To deal with this problem, a WWW document acquiring system 4 shown in FIG. 11 has been proposed. Details of such a system are given below.

The WWW document acquiring system 4 includes a client 110, a relay server 120, and a document server 130. The client 110 has a browser 111. The relay server 120 is provided with a proxy server 121, a document converter 122, and a document cache 123. A network H between the client 110 and the relay server 120 is a wireless communication network used in, for example, cellular telephones. A network I between the relay server 120 and the document server 130 is, for example, the Internet.

The basic operation of the above-configured WWW document acquiring system 4 is as follows. The client 110 connects itself to the document server 130 via the relay server 120. Then, the relay server 120 converts the document received from the document server 130 into a simpler document by using the document converter 122, and then returns it to the client 110.

The process for displaying a document in the client 110 is indicated by the flow chart of FIG. 12. In step S100, a user of the client 110 inputs a URL to issue a document request.

Then, in step S101, the relay server 120 transfers the document request to the document server 130 designated by the URL. In step S102, the document server 130 sends the requested document to the relay server 120.

In step S103, the relay server 120 converts the document received from the document server 130. During the document conversion, the relay server 120 deletes specific tags or scripts in a document or an image, or substitutes an image with a smaller amount of image data in a smaller image frame. In step S104, the converted document is then sent from the relay server 120 to the client 110.

Finally, in step S105, the client 110 displays the converted document by using the browser 111.

In the above-described WWW document acquiring system 4, a plurality of the clients 110, the relay servers 120, and the document servers 130 may be provided. The converted document may be returned from the relay server 120 to the client 110 as follows. The document may be stored in the document cache 123 of the relay server 120, and the URL which specifies the stored document may be returned to the client 110. The client 110 may then issue a request to send the document designated by the URL.

In addition to the above-described system 4 using a portable terminal, a system for distributing digital television broadcasts received by a broadcast receiver to a remote terminal, which serves as a client, and for displaying the broadcast in the remote terminal has been proposed. This system is disclosed in, for example, Japanese Patent Application No. 12-055054.

In digital television data broadcasts, as well as in WWW documents, a markup language is sometimes used. For example, in broadcast satellite (BS) digital broadcasts, the Broadcast Markup Language (BML) is used. Details of BML are described in the Association of Radio Industries and Businesses (ARIB) STD-B24 1.0 version of the ARIB standards. BML is a language based on XHTML 1.0 defined by the W3C and is modified by extending this language so that script description is possible and functions required for broadcast services are provided.

The following user interface system has also been proposed. To control devices connected to a network by using a remote controller, an operation menu displayed on the remote controller is indicated by a document described in a language, such as HTML, and a device control signal is sent to a controlled device by a script embedded in or attached to the document. This system is disclosed in, for example, Japanese Patent Application No. 12-055055.

However, the above-described conventional systems present the following problems.

In the system using a portable terminal, the scripts are deleted by the document converter, or, even if they are returned to the client without being deleted, they cannot be executed if the client is not provided with a function for executing scripts.

In order to execute all the scripts in the client, the client must have a script execution environment. Accordingly, the configuration of the client becomes complicated, resulting in an increased cost. Thus, it is not practical to use such a client as a portable terminal, such as a cellular telephone or a PDA.

Thus, the demand for executing a script embedded in or attached to a WWW document in a portable terminal used as a client cannot be implemented by the above-described conventional system.

In the system for distributing a broadcast described by a markup language received from a broadcast receiver to a remote terminal used as a client and for displaying the broadcast in the remote terminal, the above-described problems are also presented. Additionally, unless the client browser is provided with special extended functions concerning, for example, encryption and communication, which are provided for the broadcast receiver, the scripts in the data broadcast cannot be executed. That is, in the above-described BML, special extended functions concerning, for example, encryption and communication, which must be provided for the broadcast receiver, are defined, and such extended functions are executed by using scripts. Accordingly, as discussed above, when a data broadcast received from the broadcast receiver is distributed to a remote terminal, which serves as a client, and is displayed, the script contained in the BML of the data broadcast cannot be executed unless the client browser is also provided with such extended functions. It is not practical or useful to individually provide the broadcast receiver and all the clients with an encryption/authentication device, a communication device, and a large-capacity storage device required for executing scripts. The configuration of the client would also become complicated, resulting in an increased cost.

In the user interface system for controlling devices connected to a network by using a remote controller, a script execution environment is required for all the remote controllers when issuing a device control signal to a controlled device by a script contained in an operation menu displayed on the remote controller. Accordingly, the configuration of the remote controller becomes complicated, resulting in an increased cost.

### SUMMARY OF THE INVENTION

Accordingly, in view of the above-described background, it is an object of the present invention to provide a conversion apparatus and method which allow a client to execute scripts without a script execution environment, and also to provide a script conversion system including a converter, and a script conversion method.

It is another object of the present invention to provide an accounting method for billing a client using the above-described script conversion system.

In order to achieve the above-described objects, according to one aspect of the present invention, there is provided a conversion apparatus for receiving a document and a script. The conversion apparatus includes a memory device for extracting at least the script from the document and the script, and for separately storing the script in a storage unit. A substitution unit substitutes a script calling portion in the document with a portion for calling the script stored in the storage unit.

According to another aspect of the present invention, there is provided a conversion method for receiving a document and a script from a document server. The conversion method includes: a storage step of extracting at least the script from the document and the script and separately storing the script in a storage unit; and a substitution step of substituting a script calling portion in the document with a portion for calling the script stored in the storage unit, and outputting a resulting document to a client.

According to the aforementioned conversion apparatus and method, after the document is converted, the script stored in the storage unit is called.

According to still another aspect of the present invention, there is provided a script conversion system including a relay server for sending and receiving data to and from at least one client. The script conversion system is used for requesting a document and displaying the requested document by the client. The relay server includes: a converter for receiving a document and a script, extracting at least the script from the document and the script and separately storing the script in a storage unit, substituting a script calling portion in the document with a portion for calling the script stored in the storage unit, and outputting a resulting document as a converted document; and a script execution unit for executing the script. The relay server sends the converted document to the client, and a script in the converted document called by the client is executed by the script execution unit.

According to a further aspect of the present invention, there is provided a script conversion method for requesting from at least one client to a document server to send a document via a relay server and displaying the requested document in the client and for displaying the received document. The script conversion method includes: a conversion step of receiving the document and a script from the document server by the relay server, extracting at least the script from the document and the script and separately storing the script in a storage unit, substituting a script calling portion with a portion for calling the script stored in the storage unit, and outputting a resulting document as a converted document; and a script execution step of sending the converted document to the client and executing a script in the converted document called by the client.

According to the script conversion system and method, the script simply calls the script in the converted document, and then, the relay server automatically executes the script. Accordingly, it is not necessary that the client possess a script execution environment. Thus, the configuration of the client is simplified.

According to a yet further aspect of the present invention, there is provided an accounting method including: an authentication step of receiving ID information provided for a client, comparing the ID information with a list of ID information which is allowed to use a relay server, and determining whether the client is allowed to use the relay server based on a comparison result; and an accounting step of performing accounting to bill the client which is determined to be allowed to use the relay server in the authentication step for the use of: a conversion function for receiving a document and a script from a document server, extracting at least the script from the document and the script and separately storing the script in a storage unit, substituting a script calling portion in the document with a portion for calling the script stored in the storage unit, and outputting a resulting document as a converted document; and an execution function for returning the converted document to the client and executing the script in the converted document called by the client.

According to the aforementioned accounting method, the client is provided with the ID information, and the relay server is provided with the authentication/accounting unit. Thus, accounting can be performed to bill the client for the use of the relay server.

According to a further aspect of the present invention, there is provided a script conversion system including a broadcast station transmitter and a broadcast receiver for receiving a broadcast containing a document from the broadcast station transmitter and for outputting the document to at least one client and displaying the document in the client. The broadcast receiver includes: a converter for receiving the document and a script, extracting at least the script from the document and the script and separately storing the script in a storage unit, substituting a script calling portion in the document with a portion for calling the script stored in the storage device, and outputting a resulting document as a converted document; and a script execution unit for executing the script. The broadcast receiver sends the converted document to the client, and the script in the converted document called by the client is executed by the script execution unit.

According to a further aspect of the present invention, there is provided a script conversion method for receiving a broadcast containing a document from a broadcast station transmitter by a broadcast receiver, and for distributing the document from the broadcast receiver to at least one client and displaying the document in the client. The script conversion method includes: a conversion step of receiving the document and a script from the broadcast station transmitter by the broadcast receiver, extracting at least the script from the document and the script and separately storing the script in a storage unit, substituting a script calling portion in the document with a portion for calling the script stored in the storage unit, and outputting a resulting document as a converted document; and a script execution step of sending the converted document to the client, and of executing the script in the converted document called by the client.

According to the script conversion system and method, the client simply calls the script in the converted document, and then, the broadcast receiver automatically executes the script stored in the storage unit. Thus, special extended functions concerning, for example, encryption and communication, provided only for the broadcast receiver can be used in response to a request from the client. Additionally, it is not necessary to individually provide all the clients with an encryption/authentication device, a communication device, a large-capacity storage device, etc. Thus, the configuration of the client can be simplified.

According to a further aspect of the present invention, there is provided a script conversion system including a client, a remote control server for issuing a device control signal by executing a script in an operation menu document displayed in the client, a controlled device controlled by the device control signal. The remote control server includes: a converter for receiving a document and the script, extracting at least the script from the document and the script and separately storing the script in a storage unit, substituting a script calling portion in the document with a portion for calling the script stored in the storage unit, and outputting a resulting document as a converted document; and a script execution unit for executing the script. The remote control server sends the converted document to the client, and the script in the converted document called by the client is executed by the script execution unit.

According to a further aspect of the present invention, there is provided a script conversion method for issuing a device control signal by a script in an operation menu document displayed in a client to a controlled device when the client controls the controlled device via a remote control server. The script conversion method includes: a conversion step of receiving a document and the script, extracting at least the script from the document and the script and separately storing the script in a storage unit, substituting a script calling portion in the document with a portion for calling the script stored in the storage unit, and outputting a resulting document as a converted document; and a script execution step of sending the converted document to the client, and of executing the script in the converted document called by the client.

According to the script conversion system and method, the client simply calls the script in the converted document, and then, the remote control server automatically executes the script stored in the storage unit. Accordingly, it is not necessary that the client possess a script execution environment. Thus, the configuration of the client is simplified.

According to a further aspect of the present invention, there is provided an accounting method including: an authentication step of receiving ID information from a remote control server or from a client for controlling a controlled device via the remote control server, comparing the ID information with a list of ID information which is allowed to use the remote control server, and determining whether the client is allowed to use the remote control server based on a comparison result; and an accounting step of performing accounting to bill the client which is determined to be allowed to use the remote control server in the authentication step for the use of: a conversion function for receiving the document and the script, extracting at least the script from the document and the script and separately storing the script in the storage unit, substituting the script calling portion in the document with the portion for calling the script stored in the storage unit, and outputting a resulting document as a converted document; an execution function for returning the converted document to the client and executing the script in the converted document called by the client; and a control function for controlling the controlled device by the device control signal generated as a result of executing the script.

According to the aforementioned accounting method, accounting can be performed to bill the client for the use of the remote control server.

### BRIEF DESCRIPTION OF THE DRAWINGS

FIG. 1 illustrates the configuration of a portable-terminal conversion system according to a first embodiment of the present invention;

FIG. 2 is a flow chart illustrating the operation performed by the portable-terminal conversion system shown in FIG. 1;

FIG. 3 illustrates an example of a document to be input into a conversion apparatus according to the present invention;

FIG. 4 illustrates an example of a document converted by a conversion apparatus according to the present invention;

FIG. 5 illustrates the configuration of a broadcasting conversion system according to a second embodiment of the present invention;

FIG. 6 is a flow chart illustrating the operation performed by the broadcasting conversion system shown in FIG. 5;

FIG. 7 illustrates the configuration of a remote-controlling conversion system according to a third embodiment of the present invention;

FIG. 8 is a flow chart illustrating the operation performed by the remote-controlling conversion system shown in FIG. 7;

FIG. 9 is a flow chart illustrating the operation performed by the remote-controlling conversion system shown in FIG. 7 when a remote control server converts documents in advance;

FIG. 10 is a flow chart illustrating the operation performed by the remote-controlling conversion system shown in FIG. 7 when a controlled device provides documents;

FIG. 11 illustrates the configuration of a known WWW document acquiring system; and

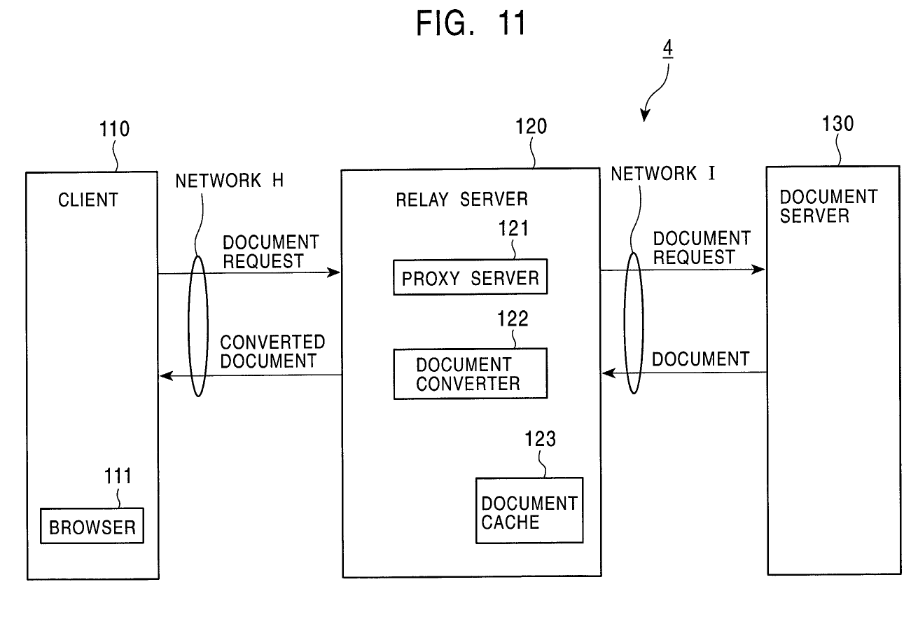

FIG. 12 is a flow chart illustrating the operation performed by the WWW document acquiring system.

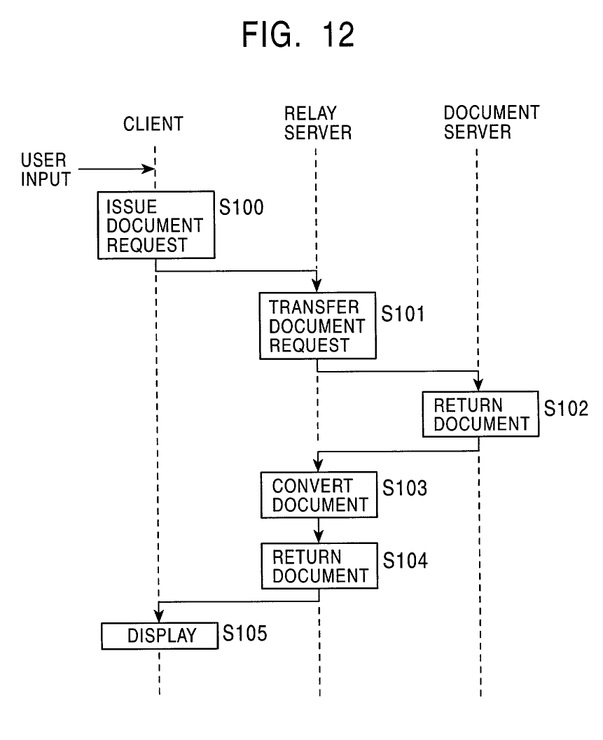

### DESCRIPTION OF THE PREFERRED EMBODIMENTS

The present invention is described in detail below with reference to the accompanying drawings through illustration of preferred embodiments.

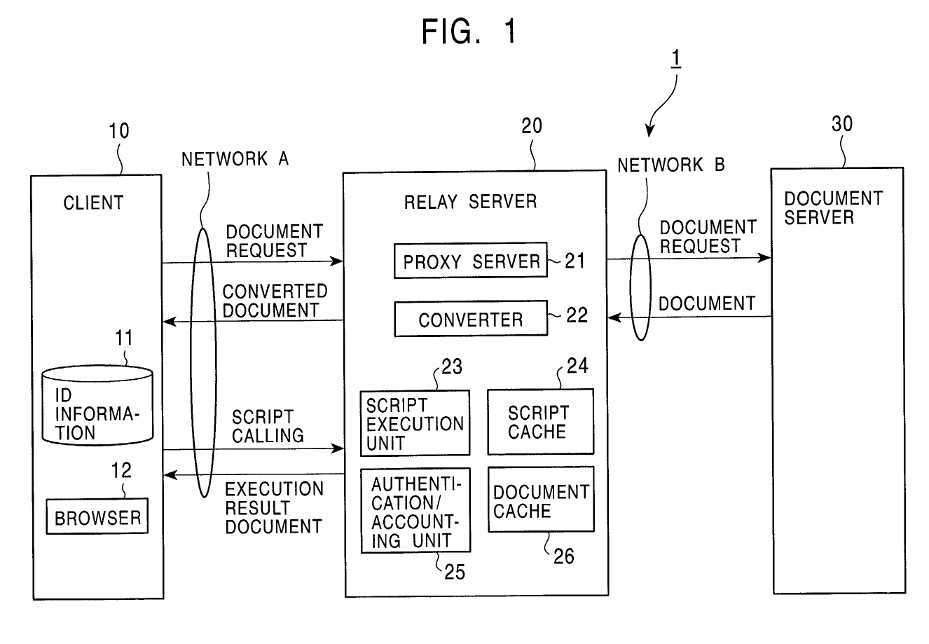

FIG. 1 illustrates the configuration of a portable-terminal conversion system 1 according to a first embodiment of the present invention. The portable-terminal conversion system 1 includes a client 10, a relay server 20, and a document server 30. The client 10 is a portable terminal, such as a cellular telephone or a PDA. A network A between the client 10 and the relay server 20 is a wireless communication network if the client 10 is a cellular telephone. A network B between the relay server 20 and the document server 30 is, for example, the Internet.

The client 10 has a browser 12. The client also has unique ID information 11 which specifies the caller. The relay server 20 includes a proxy server 21, a converter 22, a script execution unit 23, a script cache 24, which serves as script storage means, an authentication/accounting device 25, and a document cache 26, which serves as document storage means.

The basic operation of the portable-terminal conversion system 1 is as follows. The client 10 connects itself to the document server 30 via the proxy server 21 of the relay server 20, and the relay server 20 converts a document received from the document server 30 by using the converter 22. Then, the converted document is returned to the client 10 and is displayed by using the browser 12.

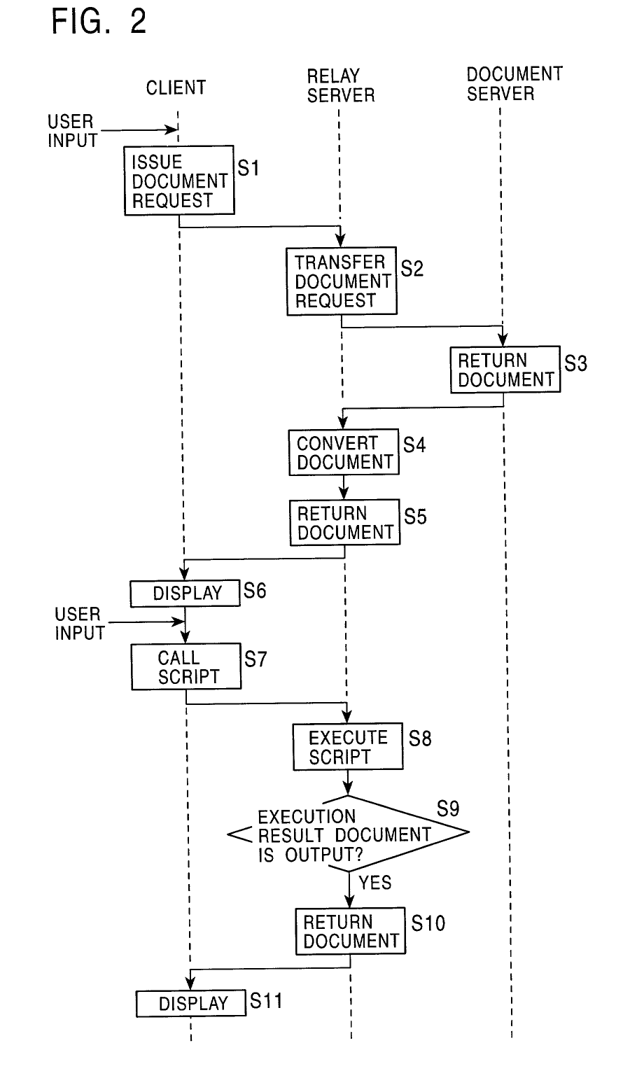

The process for displaying a document in the portable-terminal conversion system 1 is indicated by the flow chart of FIG. 2. In step S1, a user of the client 10 inputs a URL to issue a document request.

Then, in step S2, the relay server 20 transfers the document request to the document server 30 designated by the URL. In step S3, the document server 30 sends the requested document to the relay server 20.

Subsequently, in step S4, the relay server 20 converts the document returned from the document server 30. An overview of the document conversion is as follows, though details thereof are given later. A script is extracted from the document and is stored in the script cache 24. Then, a portion in which script calling is described is substituted with a description of a program for calling the script stored in the relay server 20. In step S5, the document converted by the relay server 20 as described above is returned to the client 10. Then, in step S6, the converted document is displayed by using the browser 12.

In step S7, the user of the client 10 calls the script by performing an input operation on the displayed document. In this operation, the script in the relay server 20 is called since the document has been converted in the relay server 20 in step S4. Subsequently, in step S8, the relay server 20 executes the script called by the client 10 by using the script execution unit 23. Accordingly, when the client 10 calls a script, the script is automatically executed in the relay server 20.

During the above-described operation, the converter 22 of the relay server 30 may store the document returned from the document server 30 and a script embedded in or attached to the document in the document cache 26. In this case, if the script indicates that part of the document other than the script is to be rewritten by executing the script, the rewritten document can be returned to the client 10 as an execution result document since the original document is stored in the document cache 26, and the rewritten document can be displayed. That is, in this case, it is found in step S9 that the execution result document is to be output to the client 10. Then, in step S10, the execution result document is returned to the client 10. Subsequently, in step S11, the client 10 displays the execution result document by using the browser 12.

If the execution result document is output by executing the script, the execution result document may be stored in the document cache 26 of the relay server 20, and the URL designating the stored document may be returned to the client 10. Then, the client 10 may issue a request to send the document designated by the URL. According to the above-described process, the document is displayed in the portable-terminal conversion system 1.

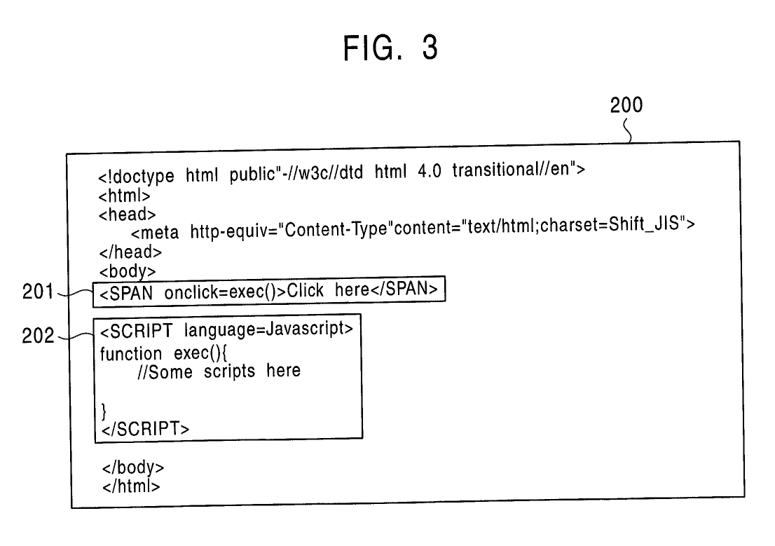

Details of the converter 22 provided for the relay server 20 are given below. The converter 22 has the known function of deleting special tags, such as script tags, contained in an image or a document, or substituting an image with a smaller amount of image data in a smaller image frame. In addition to this known function, the converter 22 also has the function of detecting a script embedded in or attached to the document, deleting the script, and storing it in the script cache 24. For example, a document 200 described in HTML, such as that shown in FIG. 3, is input into the converter 22, and then, a script 202 indicated by script tags is detected and deleted from the document 200. The script 202 is then stored in the script cache 24.

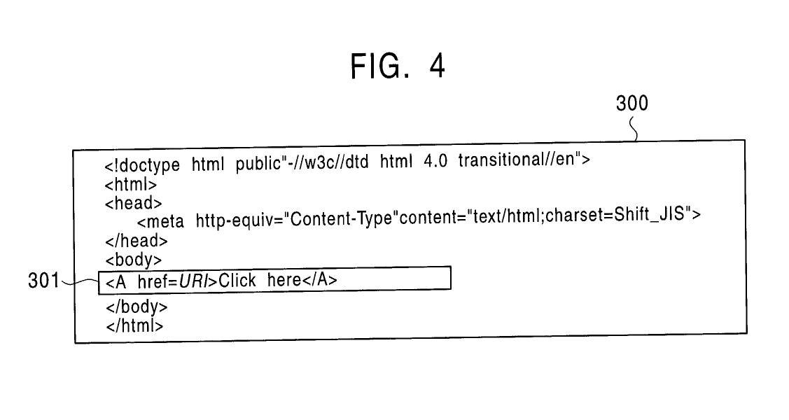

After storing the script, a script calling portion is detected, and is substituted with a portion for calling the script stored in the script cache 24. For example, in the document 200 shown in FIG. 3, a script calling portion 201 for the script 202 is detected, and is substituted with a description of a program for calling the script 202. A result obtained by converting the document 200 by the converter 22 is indicated by a converted document 300 shown in FIG. 4.

In the document 300, the script calling portion 201 is substituted with a script calling portion 301 including an HTML A (Anchor) tag for calling the script stored in the relay server 20. The A tag is a tag which designates the URI as the href attribute so as to link to WWW resources. In the URI portion indicated by italics in the converted script calling portion 301, a URI which specifies the script stored in the relay server 20 is embedded.

By substituting the script calling portion 201 with the script calling portion 301 including the A tag, as discussed above, the script in the relay server 20 is called by the client 10. Since the script is stored in the script cache 24 by the converter 22 itself, the converter 22 is able to assign a unique URI specifying the stored script.

A description is now given of an accounting method for use in the portable-terminal conversion system 1 according to the first embodiment. The client 10 has the ID information 11 which specifies the caller. If the client 10 is, for example, a cellular telephone, the ID information 11 is information which specifies the number of the cellular telephone and the caller to be billed. The relay server 20 is provided with the authentication/accounting unit 25 for receiving the ID information 11 from the client 10 and performing authentication and accounting processing.

Thus, in the portable-terminal conversion system 1, accounting can be performed for utilizing the above-described conversion function of the relay server 20 and an execution function of returning the converted document to the client 10 and executing the script called by the client 10.

Upon receiving the ID information 11 from the client 10, the authentication/accounting unit 25 compares the ID information 11 with a list of IDs which are allowed to use the above-described conversion function and the execution function. If the ID information 11 is authenticated, the client 10 is allowed to use the conversion function and the execution function. In order to utilize the conversion function and the execution function, the user is required to register the ID in the relay server 20 in advance. Every time the authenticated client 10 utilizes the conversion function and the execution function, the authentication/accounting unit 25 updates accounting information corresponding to the ID information 11 received from the client 10. It is thus possible to perform accounting according to the use of the above-described functions.

As described above, in the portable-terminal conversion system 1 according to the first embodiment, it is not necessary that the client 10 possess a script execution environment. Accordingly, the configuration of the client 10 is simplified.

In the examples shown in FIGS. 3 and 4, the script calling portion 201 is substituted by using the A tag. However, it is not essential that the A tag be used. For example, HTML FORM may be employed for substituting the script calling portion 201 with a description for calling the script via a CGI of the relay server 20 or with a script for calling the script of the relay server 20. If the script calling portion is substituted with a script, the client 10 is required to execute that script. However, in the portable-terminal conversion system 1 of the first embodiment, all scripts other than the above-described script are executed in the relay server 20, and thus, the client 10 is required to execute only the script for calling the script stored in the relay server 20. In this case, at least an execution environment for executing the script for calling the script of the relay server 20 is provided in the client 10.

The document converted by the converter 22 is not dependent upon a specific language. All the documents having a script therein or attached thereto can be converted by the converter 22. A document encoded in binary data can also be converted.

The relay server 20 may have the functions of the document server 30, in which case, documents are stored in the relay server 20 in advance. That is, the relay server 20 may be provided with document storage means which serve the functions of the document server 30. In this case, the document server 30 is not necessary.

The document may be divided into a description and a script embedded in or attached to the document, and the description and the script may be separately provided as the document. For example, the description and the script may be separately provided directly from different document servers or from different document servers via external recording media. In this case, as in the first embodiment, the converter 22 stores the script in the script cache 24 of the relay server 20, and substitutes the script calling portion in the document with a portion for calling the script stored in the script cache 24. Accordingly, in this modification, the document can also be converted by the converter 22.

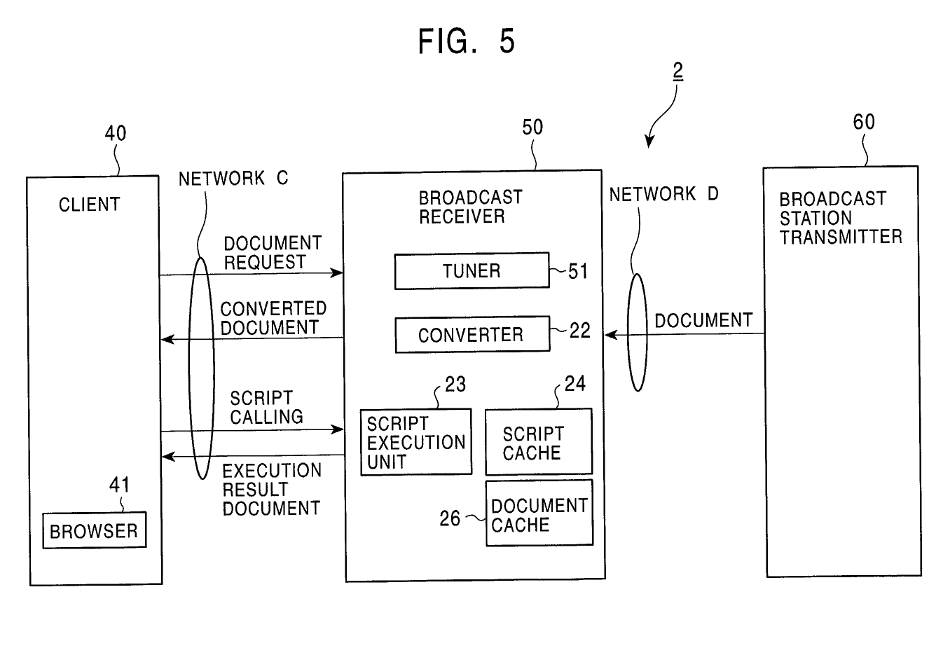

FIG. 5 illustrates the configuration of a broadcasting conversion system 2 according to a second embodiment of the present invention. The basic configuration of the broadcasting conversion system 2 is similar to that of the portable-terminal conversion system 1 shown in FIG. 1. The feature of the second embodiment is that a data broadcast including a document is received by a broadcast receiver 50 and is distributed to a broadcast receiving remote terminal, which serves as a client 40. That is, a document is provided by a broadcast station transmitter 60 instead of the document server 30. In FIG. 5, the same elements as those shown in FIG. 1 are indicated by like reference numerals, and an explanation thereof will thus be omitted.

The broadcasting conversion system 2 includes the client 40, the broadcast receiver 50, and the broadcast station transmitter 60. A network C between the client 40 and the broadcast receiver 50 is, for example, an infrared or wireless data transmission medium. A network D between the broadcast receiver 50 and the broadcast station transmitter 60 is a broadcast transmission medium. However, the broadcasting conversion system 2 does not depend on the type of transmission medium.

The client 40 has a browser 41. The broadcast receiver 50 includes a tuner 51, the converter 22, the script execution unit 23, the script cache 24, which serves as script storage means, and the document cache 26, which serves as document storage means.

The basic operation of the broadcasting conversion system 2 is as follows. In response to a request to send a document from the client 40, the broadcast receiver 50 extracts the requested document by using the tuner 51, and converts it by using the converter 22. The converted document is then returned to the client 40, and is displayed by using the browser 41.

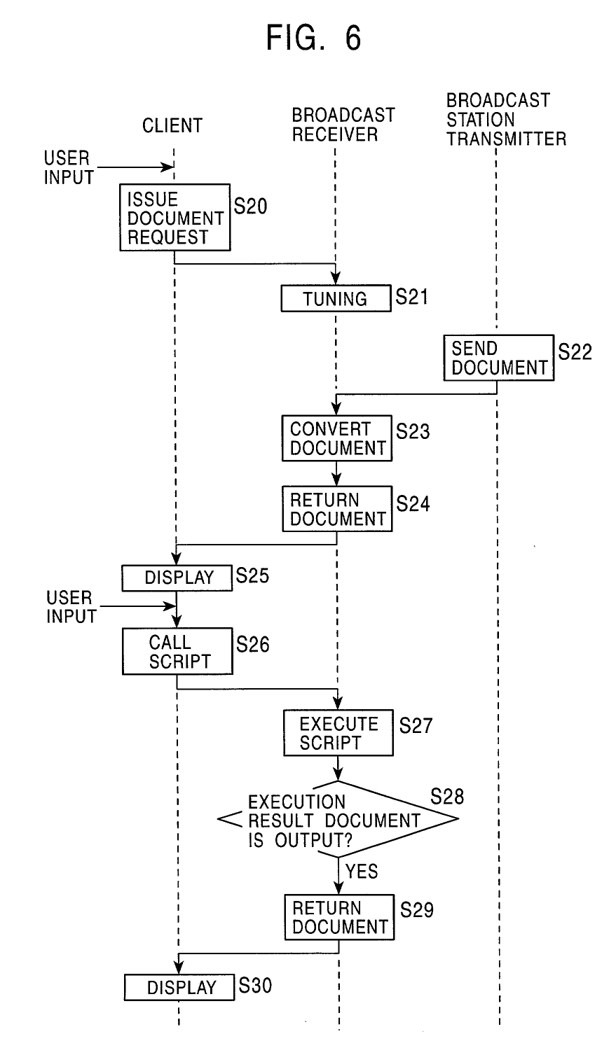

The process for displaying a document in the broadcasting conversion system 2 is indicated by the flow chart of FIG. 6. In step S20, a user of the client 40 issues a document request by selecting a desired program.

Then, in step S21, according to the document request from the client 20, i.e., according to the program channel selected by the client 20, the broadcast receiver 50 extracts the requested document from broadcast data received from the broadcast station transmitter 60. Generally, the broadcast station transmitter 60 constantly transmits data broadcasting documents, and the above-described broadcast data stored in the broadcast receiver 50 is transmitted from the broadcast station transmitter 60 in step S22.

Subsequently, in step S23, the broadcast receiver 50 converts the extracted document according to a procedure similar to that of the first embodiment. That is, the converter 22 extracts and deletes a script from the document, and stores it in the script cache 24. The converter 22 then substitutes a script calling portion in the document with a description of a program for calling the script stored in the script cache 24. In step S24, the converted document is returned to the client 40 from the broadcast receiver 50. In step S25, the returned document is displayed by using the browser 41.

The document conversion in step S23 may be performed in the broadcast receiver 50 before a document request is issued by the client 40. In this case, upon issuing a document request, the converted document is sent to the client 40, and is displayed by using the browser 41. With this modification, the time required for displaying a document requested by the client 40 is decreased.

In step S26, a script is called by performing an input operation by the user of the client 40 on the displayed document. In this operation, the script in the broadcast receiver 50 is called from the user since the script calling portion is substituted with the portion for calling the script stored in the script cache 24 by the converter 22 in step S23. Then, in step S27, the broadcast receiver 50 executes the script by using the script execution unit 23.

Some scripts may include an instruction to output an execution result as a document. In this case, it is found in step S28 that the execution result document is output. Then, in step S29, the execution result document is sent to the client 40. Finally, in step S30, the execution result document is displayed by using the browser 41.

Instead of directly outputting the execution result document to the client 40, it may be stored in the document cache 26 of the broadcast receiver 50, and the URL designating the stored document may be returned to the client 40. Then, the client 40 may issue a request to send the document designated by the URL.

As in the portable-terminal conversion system 1 of the first embodiment, the document and the script embedded in or attached to the document may be stored in the document cache 26.

In this case, if the script indicates that part of the document other than the script is to be rewritten by executing the script, the rewritten document can be returned to the client 40 as an execution result document and is displayed since the original document is stored in the document cache 26.

The document may be divided into a description and a script embedded in or attached to the document, and the description and the script may be separately provided as the document. For example, the description and the script may be separately provided directly from different broadcast station transmitters or from different broadcast station transmitters via external recording media. Alternatively, they may be separately provided from different program channels transmitted from a broadcast station transmitter. In this case, as in the second embodiment, the converter 22 stores the script in the script cache 24 of the broadcast receiver 50, and substitutes a script calling portion in the document with a portion for calling the script stored in the script cache 24. Accordingly, in this modification, as in the second embodiment, the document can be converted by the converter 22.

As described above, the broadcasting conversion system 2 of the second embodiment, it is not necessary that the client 40 possess a script execution environment. For example, even if the script includes a special extended function, which requires an encryption/authentication device, a communication device, and a large-capacity storage device, it is not necessary to provide the client 40 with these devices since the script is executed in the broadcast receiver 50. In this case, the script is executable in the broadcast receiver 50 as long as the broadcast receiver 50 is provided with a special extended function. Accordingly, the configuration of the client 40 is simplified.

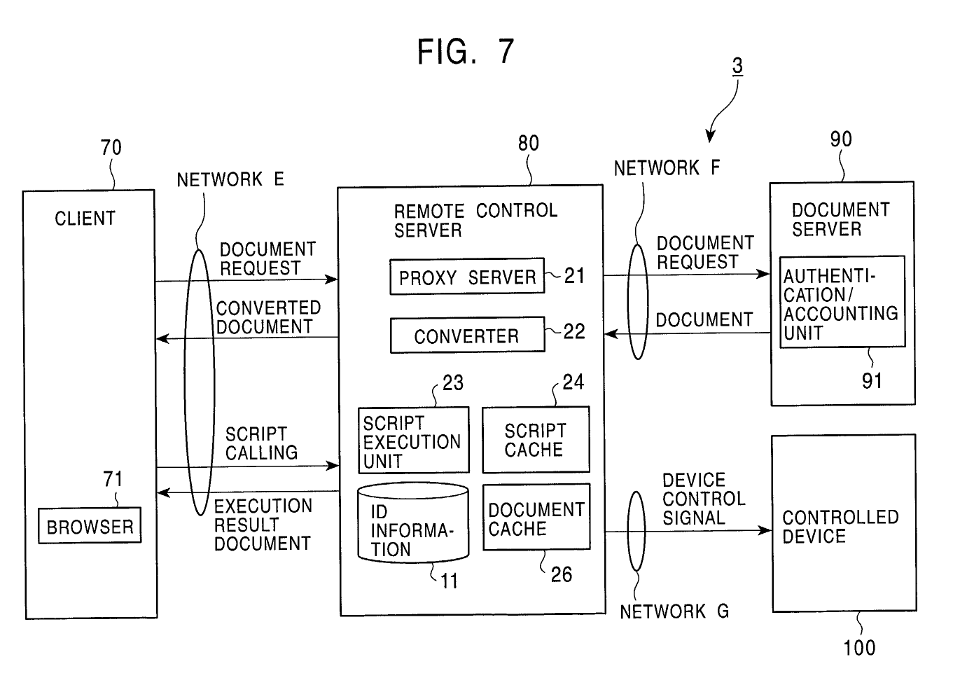

FIG. 7 illustrates the configuration of a remote-controlling conversion system 3 according to a third embodiment of the present invention. The basic configuration of the remote-controlling conversion system 3 is similar to that of the portable-terminal conversion system 1 shown in FIG. 1. The feature of the third embodiment is that a client 70, which is a remote controller, controls a device connected to a network G. In FIG. 7, the same elements as those shown in FIG. 1 are designated with like reference numerals, and an explanation thereof will thus be omitted.

The remote-controlling conversion system 3 includes the client 70, a remote control server 80, a document server 90, and a controlled device 100. A network E between the client 70 and the remote control server 80 is, for example, an infrared or wireless data transmission medium. However, the remote-controlling conversion system 3 does not depend on the type of transmission medium. A network F between the remote control server 80 and the document server 90 is, for example, the Internet. The network G between the remote control server 80 and the controlled device 100 is a network defined by, for example, IEEE1394. A device control signal may be a signal defined by, for example, AV/C Digital Interface Command Set of the 1394 Trade Association. However, the remote-controlling conversion system 3 does not depend on the type of transmission medium or the command set. In the remote-controlling conversion system 3, a plurality of the clients 70, the remote control servers 80, the document servers 90, and the controlled devices 100 may be provided and connected.

The client 70 possesses a browser 71. The remote control server 80 has the proxy server 21, the converter 22, the script execution unit 23, the script cache 24, and the document cache 26. The remote control server 80 is also provided with the ID information 11. The document server 90 possesses the authentication/accounting unit 91.

The basic operation of the remote-controlling conversion system 3 is as follows. The client 70 connects itself to the document server 90 via the proxy server 21 of the remote control server 80. The remote control server 80 then converts a document returned from the document server 90 by using the converter 22. The converted document is returned to the client 70, and is displayed by using the browser 71.

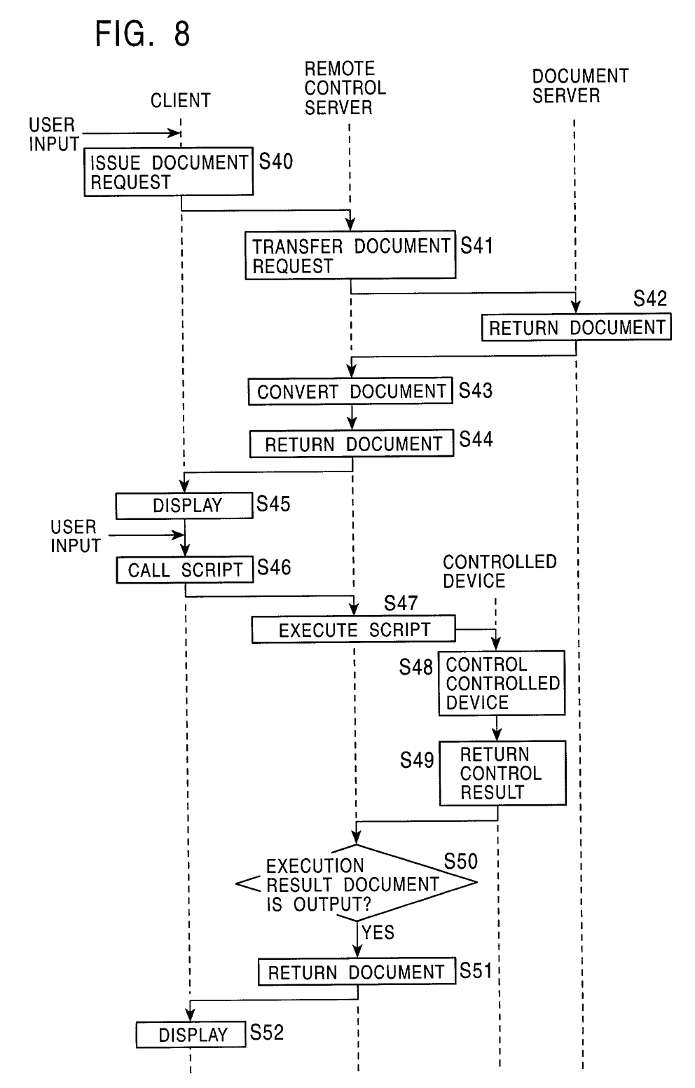

The process for displaying a document in the remote-controlling conversions system 3 is indicated by the flow chart of FIG. 8. In step S40, a user of the client 70, which is a remote controller, issues a document request by inputting a URL designating a desired menu.

Then, in step S41, the remote control server 80 transfers the document request to the document server 90 designated by the URL. In step S42, the document server 90 sends the requested document to the remote control server 80.

Subsequently, in step S43, the remote control server 80 converts the document according to a procedure similar to that of the first embodiment. That is, the converter 22 extracts and deletes a script for transmitting a device control signal to the controlled device 100, and stores the script in the script cache 24. The converter 22 then substitutes a script calling portion in the document with a description of a program for calling the script stored in the script cache 24.

In step S44, the document converted by the converter 22 as discussed above is returned to the client 70 from the remote control server 80. In step S45, the document is displayed by using the browser 71.

Subsequently, in step S46, a user of the client 70 calls a script by performing an input operation on the displayed document. In this operation, the script in the remote control server 80 is called since the script calling portion has been substituted with the script stored in the remote control server 80. Then, in step S47, the remote control server 80 executes the called script by using the script execution unit 23.

In step S48, a device control signal generated as a result of executing the script in step S47 controls the controlled device 100. In step S49, the controlled device 100 may return a control result to the script of the remote control server 80. An execution result may be output as a document according to the type of script. Then, if is it found in step S50 that the execution result document is output, in step S71, the execution result document is returned to the client 70. In step S52, the returned document is displayed by using the browser 71.

Instead of directly outputting the execution result document to the client 70, it may be stored in the document cache 26 of the remote control server 80, and the URL designating the stored document may be returned to the client 70. Then, the client 70 may issue a request to send the document designated by the URL.

An accounting method for use in the remote-controlling conversion system 3 according to the third embodiment of the present invention is described below. As discussed above, the remote control server 80 has the ID information 11 which specifies the caller. The document server 90 is provided with the authentication/accounting unit 91 for receiving the ID information 11 and for performing authentication and accounting processing. The authentication/accounting unit 91 performs accounting to bill for the conversion function, the execution function, and the control function.

The conversion function is to receive a document and a script, extract and store the script in the script cache 24, substitute a script calling portion in the document with a portion for calling the stored script, and then output the resulting document as a converted document. The execution function is to return the converted document to the client and to execute the script called by the client. The control function is to control the controlled device by a device control signal generated as a result of executing the script.

Upon receiving the ID information 11 from the remote control server 80, the authentication/accounting unit 91 compares the ID information 11 with a list of IDs which are allowed to use the above-described conversion function, the execution function, and the control function. If the ID information 11 is authenticated, the client 70 is allowed to use a document including a menu and a script for remote-controlling the controlled device 100. In order to utilize the above-described functions, the user is required to register the ID in the document server 90 in advance. Then, the client 70 is able to obtain a document from the document server 90. Every time the authenticated client 70 utilizes the conversion function, the execution function, and the control function, the authentication/accounting unit 91 updates accounting information corresponding to the ID information 11 received from the remote control server 80. It is thus possible to perform accounting according to the use of the above-described functions.

The ID information 11 may be possessed by the client 70 rather than the remote control server 80, and the authentication/accounting unit 91 may be provided for the remote control server 80 rather than the document server 90. Then, accounting can be performed in the remote control server 80 according to an accounting method similar to that of the first embodiment. This modification is suitable when, for example, the network E between the client 70 and the remote control server 80 is the Internet.

As described above, in the remote-controlling conversion system 3 according to the third embodiment of the present invention, when controlling a device connected to a network by a remote controller, i.e., the client 70, the client 70 is able to connect itself to the controlled device 100 via the remote control server 80 provided with the script conversion unit 22 and the script execution unit 23. With this configuration, it is not necessary that the client 70 possess a script execution environment.

A document may be sent from the document server 90 to the remote control server 80 via an external recording medium. The remote control server 80 may possess the functions of the document server 90, in which case, documents are stored in the remote control server 80 in advance. That is, the remote control server 80 may be provided with document storage means which serves the functions of the document server 90.

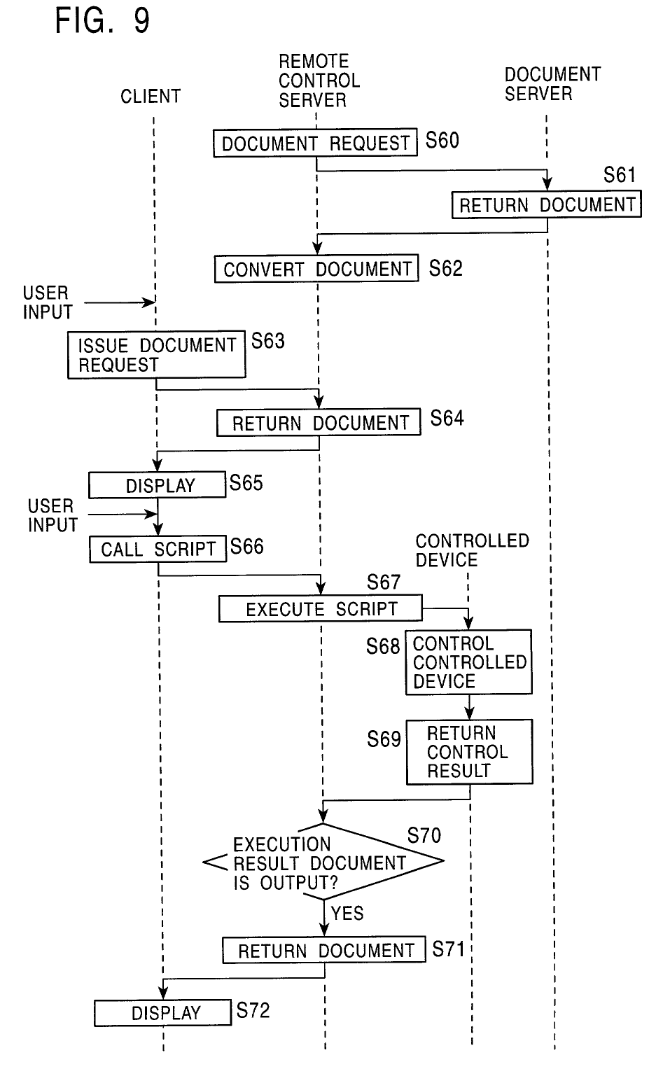

Before the client 70 issues a document request, the remote control server 80 may receive available documents from the document server 90. The operation according to this process is indicated by the flow chart of FIG. 9. In step S60, the remote control server 80 requests the document server 90 to send available documents before a document request is issued by the client 70. In step S61, the document server 90 sends the documents to the remote control server 80.

Then, in step S62, the remote control server 80 converts the documents by using the converter 22 according to a procedure similar to that of the first embodiment. That is, a script for transmitting a device control signal to the controlled device 100 is extracted and stored in the script cache 24 of the remote control server 80. A script calling portion in the document is also substituted with a description of a program for calling the script stored in the script cache 24.

Subsequently, in step S63, a user of the client 70 issues a document request by performing an input operation. Then, in step S64, the remote control server 80 extracts the requested document from the converted documents and sends it to the client 70. In step S65, the document is displayed by using the browser 71.

In step S66, the user of the client 70 calls a script by performing an input operation on the displayed document. In this operation, the script in the remote controller 80 is called since the script calling portion in the document has been substituted with the portion for calling the script stored in the remote control server 80. Then, in step S67, the remote control server 80 executes the called script by using the script execution unit 23.

Subsequently, in step S68, a device control signal generated as a result of executing the script is transmitted to the controlled device 100 and controls the controlled device 100. In step S69, the controlled device 100 may return a control result to the script in the remote control server 80. An execution result may be output as a document according to the type of script. In this case, it is found in step S70 that an execution result document is output. Then, in step S71, the execution result document is returned to the client 70. In step S72, the document is displayed by using the browser 71.

As discussed above, documents are converted before a document request is issued by the client 70. Then, when a document request is made by the client 70, the requested document is simply extracted from the stored documents and is returned to the client 70. With this modification, the time required for displaying the requested document in the client 70 is decreased.

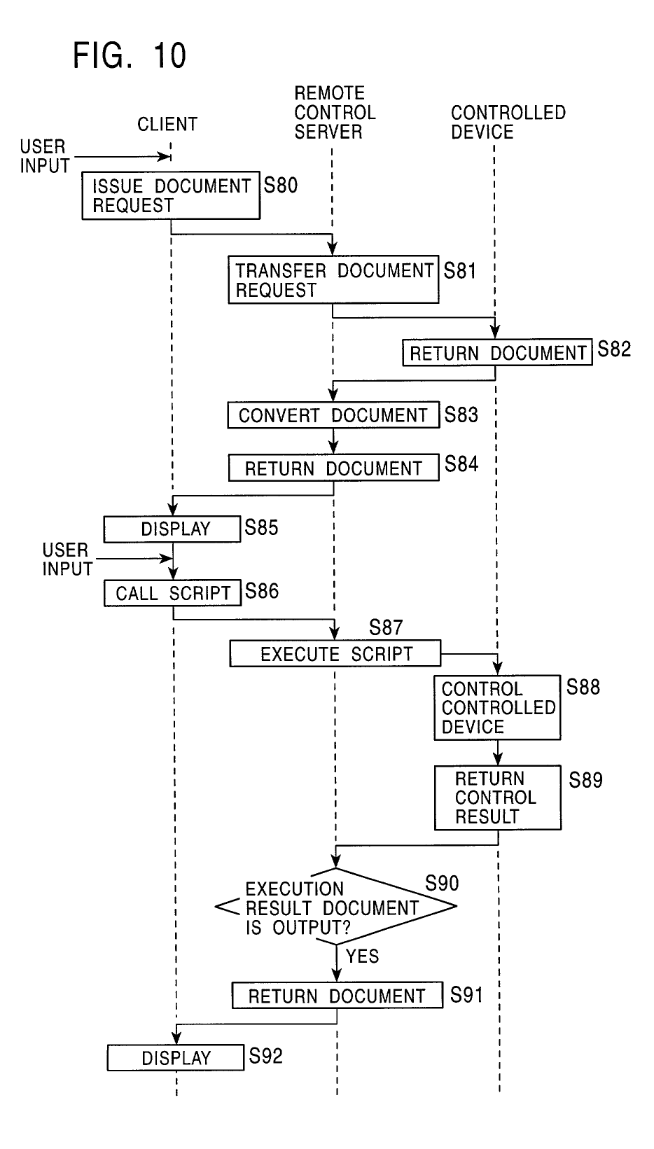

The documents may be provided from the controlled device 100. That is, the controlled device 100 may possess the functions of the document server 90, in which case, the documents are stored in the controlled device 100 in advance. The operation performed by the remote-controlling conversion system 3 is indicated by the flow chart of FIG. 10. In step S80, a user of the client 70 issues a document request by inputting a URL specifying a desired menu.

Then, in step S81, the remote controller 80 transfers the document request to the controlled device 100 designated by the URL. In step S82, the controlled device 100 returns the requested document to the remote control server 80.

Subsequently, in step S83, the remote control server 80 converts the document according to a procedure similar to that of the first embodiment. That is, the converter 22 extracts a script for transmitting a control signal to the controlled device 100, and stores the script in the script cache 24. The converter 22 then substitutes a script calling portion in the document with a description of a program for calling the script stored in the script cache 24.

In step S84, the converted document is sent from the remote control server 80 to the client 70. In step S85, the returned document is displayed by using the browser 71.

Subsequently, in step S86, the user of the client 70 calls a script by performing an input operation on the displayed document. In this operation, the script in the remote control server 80 is called since the script calling portion in the document is substituted with the portion for calling the script stored in the remote control server 80. Then, in step S87, the remote control server 80 executes the called script by using the script execution unit 23.

Subsequently, in step S88, a device control signal generated as a result of executing the script controls the controlled device 100. In step S89, the controlled device 100 may return a control result to the script in the remote control server 80. An execution result may be output as a document according to the type of script. In this case, it is found in step S90 that an execution result document is output. Then, in step S91, the execution result document is returned to the client 70. In step S92, the execution result document is displayed by using the browser 71.

The document may be divided into a description for displaying an operation menu and a script portion for controlling the controlled device 100, and the description and the script may be separately provided as the document. For example, the description and the script may be separately provided via the document server 90, the controlled device 100, or the remote control server 80, or from the document server 90, the controlled device 100, or the remote control server 80 via external recording media. In this case, as in the third embodiment, the converter 22 stores the script in the script cache 24 of the remote control server 80, and substitutes the script calling portion in the document with a portion for calling the script stored in the script cache 24. Accordingly, in this modification, as in the third embodiment, the document can be converted by the converter 22.

The present invention is not restricted to the foregoing embodiments, and various modifications and arrangements may be made without departing from the spirit of the invention. For example, the conversion method employed in the present invention may be executed by hardware or software.

What is claimed is:

1. A conversion apparatus receiving a document and a script as receiving data, comprising:
storage means for storing at least the script extracted from the receiving data; and
substitution means for substituting a script calling portion in the document with a portion for calling the script stored in said storage means.

2. A conversion apparatus according to claim 1, wherein the script is embedded in or attached to the document.

3. A conversion apparatus according to claim 2, wherein the document and the script are separately provided.

4. A conversion apparatus according to claim 1, wherein said conversion apparatus is provided in a relay server for sending and receiving data to and from a client.

5. A conversion apparatus according to claim 1, wherein said storage means stores the document and the script.

6. A conversion method comprising:
a receiving step of receiving a document and a script as receiving data;
a storage step of storing at least the script extracted from the receiving data; and
a substitution step of substituting a script calling portion in the document with a portion for calling the script stored in said storage means.

7. A conversion method according to claim 6, wherein the script is embedded in or attached to the document.

8. A conversion method according to claim 7, wherein the document and the script are separately provided.

9. A conversion method according to claim 6, wherein said storage step stores the document and the script.

10. A script conversion system comprising a relay server for sending and receiving data to and from at least one client, said script conversion system being used for requesting a document and displaying the requested document by said client,
said relay server comprising:
conversion means for receiving a document and a script, extracting at least the script from the document and the script and storing the script in storage means, substituting a script calling portion in the document with a portion for calling the script stored in said storage means, and outputting a resulting document as a converted document; and
script execution means for executing the script,
wherein said relay server sends the converted document to said client, and a script called by said client is executed by said script execution means.

11. A script conversion system according to claim 10, wherein said client comprises a portable communication terminal.

12. A script conversion system according to claim 10, wherein said relay server receives the document directly from a document server in which documents are stored, or from said document server via an external recording medium.

13. A script conversion system according to claim 10, wherein the script is embedded in or attached to the document.

14. A script conversion system according to claim 13, wherein said storage means comprises script storage means, and, when a display portion and the script, which form the document, are separately provided, said storage means stores the script in said script storage means, and the script calling portion in the document is substituted with the portion for calling the script stored in said script storage means.

15. A script conversion system according to claim 14, wherein the display portion and the script are separately provided directly from different document servers or from different document servers via external recording media.

16. A script conversion system according to claim 10, wherein said storage means comprises document storage means for storing at least the document, and said storage means stores the document and the script in said document storage means.

17. A script conversion system according to claim 10, wherein, when an execution result document obtained as a result of executing the script in said relay server is output, the execution result document is returned to said client, and is displayed in said client.

18. A script conversion system according to claim 10, wherein said client comprises ID information storage means for storing ID information which specifies a caller, and said relay server comprises authentication means for receiving the ID information from said client and for comparing the ID information with a list of ID information which is allowed to use said relay server, and wherein said authentication means determines whether said client is allowed to use said relay server based on an authentication result of said authentication means.

19. A script conversion system according to claim 18, further comprising accounting means for performing accounting to bill the client which is determined to be allowed to use said relay server by said authentication means for the use of: a conversion function for receiving the document and the script, extracting at least the script from the document and the script and separately storing the script in said storage means, substituting the script calling portion in the document with the portion for calling the script stored in said storage means, and outputting a resulting document as a converted document; and an execution function for executing the script in the converted document called by said client.

20. A script conversion system according to claim 19, wherein said accounting means updates accounting information corresponding to the ID information every time said client uses the conversion function and the execution function.

21. A script conversion system according to claim 10, wherein said relay server serves the functions of a document server by storing the document in said relay server in advance.

22. A script conversion method for requesting from at least one client to a document server to send a document via a relay server and displaying the requested document in said client and for displaying the received document, said script conversion method comprising:
a conversion step of receiving the document and a script from said document server by said relay server, extracting at least the script from the document and the script and storing the script in storage means, substituting a script calling portion with a portion for calling the script stored in said storage means, and outputting a resulting document as a converted document; and
a script execution step of sending the converted document to said client and executing a script in the converted document called by said client.

23. A script conversion method according to claim 22, wherein said client comprises a portable communication terminal.

24. A script conversion method according to claim 22, wherein the script is embedded in or attached to the document.

25. A script conversion method according to claim 24, wherein said storage means comprises script storage means, and, when a display portion and the script, which form the document, are separately provided, said conversion step stores the script in said script storage means, and substitutes the script calling portion with the portion for calling the script stored in said script storage means.

26. A script conversion method according to claim 25, wherein the display portion and the script are separately provided directly from different document servers or from different document servers via external recording media.

27. A script conversion method according to claim 22, wherein said conversion step comprises a document storage step and a script storage step, and said conversion step stores the document and the script in said document storage step.

28. An accounting method comprising:
an authentication step of receiving ID information provided for a client, comparing the ID information with a list of ID information which is allowed to use a relay server, and determining whether said client is allowed to use said relay server based on a comparison result; and
an accounting step of performing accounting to bill the client which is determined to be allowed to use said relay server in said authentication step for the use of: a conversion function for receiving a document and a script from a document server, extracting at least the script from the document and the script and storing the script in storage means, substituting a script calling portion in the document with a portion for calling the script stored in said storage means, and outputting a resulting document as a converted document; and an execution function for returning the converted document to said client and executing the script in the converted document called by said client.

29. An accounting method according to claim 28, wherein accounting information corresponding to the ID information received from said client is updated every time said client uses the conversion function and the execution function.

30. An accounting method according to claim 28, wherein said client comprises a portable communication terminal.

31. An accounting method according to claim 28, wherein the script is embedded in or attached to the document.

32. An accounting method according to claim 28, wherein said storage means comprises script storage means, and, when a display portion and the script, which form the document, are separately provided, the conversion function stores the script in said script storage means, and substitutes the script calling portion in the document with the portion for calling the script stored in said script storage means.

33. An accounting method according to claim 32, wherein the display portion and the script are separately provided directly from different document servers or from different document servers via external recording media.

34. An accounting method according to claim 28, wherein said storage means comprises document storage means for storing at least the document, and said conversion function stores the document and the script in said document storage means.

35. A script conversion system comprising a broadcast station transmitter and a broadcast receiver for receiving a broadcast containing a document from said broadcast station transmitter and for outputting the document to at least one client and displaying the document in said client,
said broadcast receiver comprising:
conversion means for receiving the document and a script, extracting at least the script from the document and the script and storing the script in storage means, substituting a script calling portion in the document with a portion for calling the script stored in said storage means, and outputting a resulting document as a converted document; and
script execution means for executing the script,
wherein said broadcast receiver sends the converted document to said client, and the script in the converted document called by said client is executed by said script execution means.

36. A script conversion system according to claim 35, wherein said client comprises a broadcast receiving remote terminal.

37. A script conversion system according to claim 35, wherein said broadcast receiver receives the document from said broadcast station transmitter via an external recording medium.

38. A script conversion system according to claim 35, wherein the script is embedded in or attached to the document.

39. A script conversion system according to claim 35, wherein said storage means comprises script storage means, and, when a display portion and the script, which form the document, are separately provided, said conversion means stores the script in said script storage means, and substitutes the script calling portion in the document with the portion for calling the script stored in said script storage means.

40. A script conversion system according to claim 39, wherein the display portion and the script are separately provided directly from different broadcast station transmitters, or from different broadcast station transmitters via external recording media, or from different program channels transmitted from a broadcast station transmitter.

41. A script conversion system according to claim 35, wherein said storage means comprises document storage means for storing at least one script, and said conversion means stores the document and the script in said document storage means.

42. A script conversion system according to claim 35, wherein, when an execution result document obtained as a result of executing the script in said broadcast receiver is output, the execution result document is returned to said client, and is displayed in said client.

43. A script conversion system according to claim 35, wherein said script execution means of said broadcast receiver executes the script by using a broadcasting extended function.

44. A script conversion method for receiving a broadcast containing a document from a broadcast station transmitter by a broadcast receiver, and for distributing the document from said broadcast receiver to at least one client and displaying the document in said client, said script conversion method comprising:
a conversion step of receiving the document and a script from said broadcast station transmitter by said broadcast receiver, extracting at least the script from the document and the script and storing the script in storage means, substituting a script calling portion in the document with a portion for calling the script stored in said storage means, and outputting a resulting document as a converted document; and
a script execution step of sending the converted document to said client, and of executing the script in the converted document called by said client.

45. A script conversion method according to claim 44, wherein said client comprises a broadcast receiving remote terminal.

46. A script conversion method according to claim 44, wherein the script is embedded in or attached to the document.

47. A script conversion method according to claim 46, wherein said storage means comprises script storage means, and, when a display portion and the script, which form the document, are separately provided, said conversion step stores the script in said script storage means, and substitutes the script calling portion in the document with the portion for calling the script stored in said script storage means.

48. A script conversion method according to claim 47, wherein the display portion and the script are separately provided directly from different broadcast station transmitters, or from different broadcast station transmitters via external recording media, or from different program channels transmitted from a broadcast station transmitter.

49. A script conversion method according to claim 44, wherein said storage means comprises document storage means for storing at least the document, and said conversion means stores the document and the script in said document storage means.

50. A script conversion system comprising a client, a remote control server for issuing a device control signal by executing a script in an operation menu document displayed in said client, a controlled device controlled by the device control signal,
said remote control server comprising:
conversion means for receiving a document and the script, extracting at least the script from the document and the script and storing the script in storage means, substituting a script calling portion in the document with a portion for calling the script stored in said storage means, and outputting a resulting document as a converted document; and
script execution means for executing the script,
wherein said remote control server sends the converted document to said client, and the script in the converted document called by said client is executed by said script execution means.

51. A script conversion system according to claim 50, wherein said client comprises a remote controller for controlling said controlled device.

52. A script conversion system according to claim 50, wherein said remote control server receives the document directly from a document server which stores documents, or from said document server via an external recording medium.

53. A script conversion system according to claim 50, wherein the script is embedded in or attached to the document.

54. A script conversion system according to claim 53, wherein said storage means comprises script storage means, and, when a display portion and the script, which form the document, are separately provided, said conversion means stores the script in said script storage means, and substitutes the script calling portion in the document with the portion for calling the script stored in said script storage means.

55. A script conversion system according to claim 54, wherein the display portion and the script are separately provided directly from different document servers or different controlled devices, or from different document servers or different controlled devices via external recording media.

56. A script conversion system according to claim 50, wherein said storage means comprises document storage means for storing at least the document, and said conversion means stores the document and the script in said document storage means.

57. A script conversion system according to claim 50, wherein, when an execution result document obtained as a result of executing the script in said remote control server is output, the execution result document is returned to said client, and is displayed in said client.

58. A script conversion system according to claim 50, wherein said remote control server serves the functions of a document server by storing the document in said remote control server in advance.

59. A script conversion system according to claim 50, wherein said remote control server receives available documents from a document server in advance, converts the received documents, and stores the converted documents, and, when a document request is issued by said client, said remote control server extracts the requested document from the stored documents and returns the extracted document to said client.

60. A script conversion system according to claim 50, wherein said controlled device serves the function of a document server for providing the document to said remote control server.

61. A script conversion system according to claim 50, wherein said remote control server comprises storage means for storing ID information which specifies a caller, and authentication means for receiving the ID information and for comparing the ID information with a list of ID information which is allowed to use said remote control server, and wherein said authentication means determines whether said client is allowed to use said remote control server based on an authentication result of said authentication means.

62. A script conversion system according to claim 61, further comprising accounting means for performing accounting to bill the client which is determined to be allowed to use said remote control server by said authentication means for the use of: a conversion function for receiving the document and the script, extracting at least the script from the document and the script and separately storing the script in said storage means, substituting the script calling portion in the document with the portion for calling the script stored in said storage means, and outputting a resulting document as a converted document; an execution function for returning the converted document to said client and executing the script in the converted document called by said client; and a control function for controlling said controlled device by the device control signal generated as a result of executing the script.

63. A script conversion system according to claim 62, wherein said accounting means updates accounting information corresponding to the ID information every time said client uses the conversion function, the execution function, and the control function.

64. A script conversion method for issuing a device control signal by a script in an operation menu document displayed in a client to a controlled device when said client controls said controlled device via a remote control server, said script conversion method comprising:
a conversion step of receiving a document and the script, extracting at least the script from the document and the script and storing the script in storage means, substituting a script calling portion in the document with a portion for calling the script stored in said storage means, and outputting a resulting document as a converted document; and
a script execution step of sending the converted document to said client, and of executing the script in the converted document called by said client.

65. A script conversion method according to claim 64, wherein said client comprises a remote controller for controlling said controlled device.

66. A script conversion method according to claim 64, wherein the script is embedded in or attached to the document.

67. A script conversion method according to claim 64, wherein said storage means comprises script storage means, and, when a display portion and the script, which form the document, are separately provided, said conversion step stores the script in said script storage means, and substitutes the script calling portion in the document with the portion for calling the script stored in said script storage means.

68. A script conversion method according to claim 64, wherein the display portion and the script are separately provided directly from different document servers or different controlled devices, or from different document servers or different controlled devices via external recording media.

69. A script conversion method according to claim 64, wherein said storage means comprises document storage means for storing at least the document, and said conversion step stores the document and the script in said document storage means.

70. An accounting method comprising:
an authentication step of receiving ID information from a remote control server or from a client for controlling a controlled device via said remote control server, comparing the ID information with a list of ID information which is allowed to use said remote control server, and determining whether said client is allowed to use said remote control server based on a comparison result; and
an accounting step of performing accounting to bill the client which is determined to be allowed to use said remote control server in said authentication step for the use of: a conversion function for receiving the document and the script, extracting at least the script from the document and the script and storing the script in said storage means, substituting the script calling portion in the document with the portion for calling the script stored in said storage means, and outputting a resulting document as a converted document; an execution function for returning the converted document to said client and executing the script in the converted document called by said client; and a control function for controlling said controlled device by the device control signal generated as a result of executing the script.

71. An accounting method according to claim 70, wherein accounting information corresponding to the ID information is updated every time said client uses the conversion function, the execution function, and the control function.

72. An accounting method according to claim 70, wherein said client comprises a remote controller for controlling said controlled device.

73. An accounting method according to claim 70, wherein the script is embedded in or attached to the document.

74. An accounting method according to claim 70, wherein said storage means comprises script storage means, and, when a display portion and the script, which form the document, are separately provided, said conversion function stores the script in said script storage means, and substitutes the script calling portion in the document with the portion for calling the script stored in said script storage means.

75. An accounting method according to claim 70, wherein the display portion and the script are separately provided directly from different document servers or different controlled devices, or from different document servers or different controlled devices via external recording media.

76. An accounting method according to claim 70, wherein said storage means comprises document storage means for storing at least the document, and said conversion function stores the document and the script in said document storage means.
